(19) United States
(12) Patent Application Publication
(10) Pub. No.: US 2016/0265464 A1
(43) Pub. Date: Sep. 15, 2016

(54) METHOD OF OPTIMIZING IDLING OF AN INTERNAL COMBUSTION ENGINE

(71) Applicant: JAGUAR LAND ROVER LIMITED, Coventry Warwickshire (GB)

(72) Inventor: Nick BROCKLEY, Whitley, Coventry, Warwickshire (GB)

(21) Appl. No.: 15/032,341

(22) PCT Filed: Oct. 16, 2014
(86) PCT No.: PCT/EP2014/072197

§ 371 Date: Apr. 27, 2016

(30) Foreign Application Priority Data
Oct. 28, 2013 (GB) 1319016.0

(51) Int. Cl. F02D 41/08; F01L 1/22; F01L 1/14; F02D 13/02; F02D 41/26

(52) U.S. Cl. CPC F02D 41/08; F02D 13/0226; F02D 41/26; F01L 1/14; F01L 1/22; F01L 2201/00

(57) ABSTRACT

A method of controlling idle speed of a reciprocating piston gasoline engine having inlet poppet valves and active tappets therefor. The method allows the volume of inlet air to be varied so that idle speed can be confined within upper and lower limits with efficient combustion. The active tappets may be electro-hydraulic.

### TECHNICAL FIELD

This invention relates to a method of optimising idling of an internal combustion engine, to a control system for providing optimised idling, and to an engine so controlled.

### BACKGROUND

A conventional reciprocating piston, internal combustion engine has poppet valves to control inflow of air to the cylinder(s) and outflow of combustion gases to an exhaust system. Opening and closing of these valves must be carefully timed to ensure efficient combustion in a four stroke cycle, and typically a camshaft controls opening and closing of the valves according to crankshaft rotational position.

It has long been realised that some variation of valve operation may be beneficial in ensuring optimum engine performance, in particular variation of valve timing and/or variation of valve lift, and/or variation of the opening duration of a valve. Inlet and exhaust valves require independent control, and accordingly separate inlet and exhaust camshafts are common.

Valve timing may be varied by relative repositioning of angular camshaft position with respect to crankshaft angle. Typically relative angular movement between end stops is provided, so as to give two valve timing regimes - for example for normal and sport modes. Intermediate angular positions have also been proposed so as to give additional timing regimes. Relative angular camshaft position is determined by a suitable electronic engine control unit (ECU), and may be implemented for example by the presence or absence of a hydraulic pressure signal in a rotational cam actuator.

Valve lift, opening duration of a valve, and overlap of inlet and exhaust valve timing may also be varied, for example by shifting a camshaft axially to present a different cam lobe to a valve, or by shifting a pivot of a camshaft rocker, again by means of an actuator.

Generally speaking such variations of valve operation are provided for all valves of a multi-cylinder engine, so that relative movement of an inlet camshaft will change an inlet valve variable associated with all cylinders.

One characteristic of the known means of varying valve operation is that they are relatively slow, not least because of inertial effects and a typically mechanical or hydraulic means of actuation. Switching from one cam regime to another may take around 300 ms.

Smoothness and responsiveness in engine operation are desirable aims, not only to ensure minimum deviation from a norm, but also to give a good driver experience along with high levels of perceived comfort and quality to the vehicle occupants.

Engine exhaust emissions should also comply with legislative limits, which are becoming increasingly severe. Such emissions can be reduced by optimising the efficiency of fuel combustion in the engine.

The requirements of smooth, responsive operation, and efficient combustion do not necessarily converge.

In order to give good performance and driver experience, it is desirable for an engine to respond quickly to changes in torque demand. One kind of torque demand is indicated by accelerator pedal position, but many other kinds of torque demand may be indicated by other vehicle systems. For example a torque-down demand may be indicated during an upshift of transmission speed ratio, or if a vehicle wheel is spinning on ice. Conversely a torque-up demand may be indicated when the vehicle engine is placed under additional load, for example upon actuation of a power steering or air conditioning pump. Systems have been proposed for prioritizing multiple demands of torque change, and these form no part of the present invention.

In a gasoline engine, rapid response to demands for torque change is affected by the volume of air in the inlet manifold, downstream of the usual throttle valve and upstream of the engine inlet valve(s). Responding to a demand for torque change by changing the position of the throttle valve may be characterized as ‘slow’ since the air already in the inlet manifold will affect engine power output for the next few combustion events. Eventually the volume of inlet air to the cylinder(s) will change as the throttle valve is adjusted, so that the torque output matches demand; however this response rate is not sufficiently fast to meet current requirements.

One combustion factor which can be quickly changed is the timing of an ignition spark at the sparking plug. The speed of response may be at least an order of magnitude faster than the effect of changing throttle valve position, and may be affected within one TDC (top dead centre) of the engine.

In order to ensure a fast response to a demand for torque change, it is known to change ignition timing to reduce the power produced during a combustion event, in anticipation that an increase in power will be required. The increase in power can be quickly achieved by changing ignition timing to the optimal position for efficient combustion, without waiting for the volume of air to be increased. A fast response of this kind can be implemented cylinder by cylinder, so that successive firing events of a multi-cylinder engine may have different timing of the ignition spark.

Thus, by way of example, an idling multi-cylinder engine may be always assumed to be subject to an imminent torque-up demand should idling speed fall below a predetermined minimum. Accordingly the throttle valve position is set to normally admit excess air to the inlet manifold, and thus via the inlet valves to the cylinders. Fuelling is generally commensurate with air volume in order to achieve stoichiometric combustion.

In order to prevent more power being produced than is necessary to overcome rotational friction, windage and the like at the desired idling speed, the ignition timing may be retarded so that combustion is relatively inefficient, but the power produced is enough to provide the desired idling speed. Inefficient combustion results in additional waste heat to be absorbed by the engine cooling system, increased fuel consumption, and unnecessary noxious exhaust emissions.

However, when a torque-up demand is received, because idling speed has fallen due to for example clutch-in of an air conditioning pump, the ignition timing can be quickly changed to optimal (within a single firing event), giving an instant increase in power and torque without a commensurate increase in air and fuel. Idling speed accordingly rises, and if idling speed reaches an upper limit the ignition timing is retarded to allow idling speed to fall. Ignition timing and throttle valve position are continually varied according to engine speed and load to maintain the desired idling speed whilst allowing instant response to a torque-up demand, but it will be understood that this speed control method has the effect of operating the vehicle engine inefficiently for substantially all of the idling time.

What is required is a means of providing rapid response to a demand for an increased idling speed, but which does not rely upon the inefficient combustion method noted above. Whilst a change of valve timing or opening duration, or overlap, or lift might contribute to a solution to this problem, the existing methods of varying valve operation are too slow.

### SUMMARY OF THE INVENTION

According to an aspect of the invention there is provided a method of optimising idling of a reciprocating piston internal combustion engine having a poppet valve at the inlet of a cylinder, an inlet manifold, and a throttle valve at the inlet to said manifold, said engine further including an active tappet for said inlet valve whereby valve lift may be adjusted on demand, said method comprising: detecting that engine speed is at or below a lower predetermined value; commanding said active tappet to permit an increased volume of air to enter said cylinder, detecting that engine speed is at or above a higher predetermined value, commanding said active tappet to permit a reduced volume of air to enter the cylinder, and repeating said method continually whilst said engine is idling.

An active tappet provides for substantially immediate change of operation of the associated valve, independent of a camshaft or other valve control device, on an event by event basis. Such a tappet may be hydraulic, and include a chamber whose volume is controlled by an electrically actuated valve, such as a bleed valve, responsive to a command from an engine ECU.

In one embodiment the volume of air entering the cylinder is varied by commanding the active tappet to vary valve lift. In another embodiment variation is by changing opening duration of the valve. In yet another embodiment variation is by changing the timing of valve opening and/or valve closing. These embodiments may be used in conjunction, in any desired combination to achieve a desirable volume and rate of in-flow of air.

As is well known, an idling engine is rotating at a low speed commensurate with minimal fuel consumption and exhaust emissions. The idling speed is selected to ensure acceptable smoothness of rotation with the capability of immediate response to an increased torque demand. A typical idling speed is around 800-1000 rpm, and may vary according to ambient conditions. Idling speed is generally commanded by the ECU but is influenced by many factors including, for example, additional loads placed on the engine by accessories such as air conditioning.

The present invention provides a method of maintaining idling speed of a gasoline engine within predetermined limits, whilst also ensuring that the vehicle engine operates at substantially optimal efficiency for all speeds with said limits. The invention allows the correct volume of air to be introduced into the cylinder at each engine combustion event, so as to permit generation of the required torque for a given engine speed at the optimal ignition timing. Deliberate retarding of ignition timing, to ensure that excess torque is not generated, is generally avoided.

Most importantly the invention provides a ‘fast’ response to torque demand since the active tappet is able to respond to a change request within one firing event, and accordingly a cylinder by cylinder strategy can be adopted in a multi-cylinder engine, in contrast to prior ‘slow’ systems reliant upon a camshaft or throttle valve related change.

The method of the invention may also include varying the timing of the ignition spark timing to provide for optimum efficiency of combustion, so that during idling ignition timing may be retarded if the volume of admitted air is increased, and ignition timing may be advanced if the volume of admitted air is reduced. Such a variation of ignition timing is generally counter to that required for idle speed control by variation of ignition timing alone.

A beneficial consequence is that the invention avoids the generation of waste heat associated with inefficient combustion. The vehicle cooling system may accordingly be made smaller. Furthermore undesirable exhaust emissions are reduced because inefficient combustion is obviated by the invention.

Within the scope of the this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF DRAWINGS

Other features of the invention will be apparent from the following description of an embodiment illustrated by way of example only in the accompanying drawings in which:

FIG. 1 shows schematically the inlet arrangement of an engine to which the present invention may be applied.

FIG. 2 illustrates graphically a conventional method of idle speed control.

FIG. 3 illustrates graphically a method of idle speed control according to the invention.

FIG. 4 is a graph illustrating the effect of retarding an ignition spark upon combustion efficiency.

FIG. 5 is a further graphical example of conventional idle speed control.

FIG. 6 is a graphical illustration of the invention applied to the example of FIG. 5.

### DESCRIPTION OF EMBODIMENT

With reference to the drawings, an internal combustion engine 10 has a cylinder 11 within which a piston 12 reciprocates. A combustion chamber 13 is defined above the piston, and contains a poppet valve 14 which is opened to admit air from an inlet port 15. The inlet port is fed from an inlet manifold 16, at the mouth of which is provided a throttle valve 17.

The poppet valve 14 is closed by a spring (not shown), and is opened by action of a rotatable cam 18 which is conventionally provided by a lobe of a camshaft (not shown). Between the cam 18 and the valve 14 is provided a tappet 19.

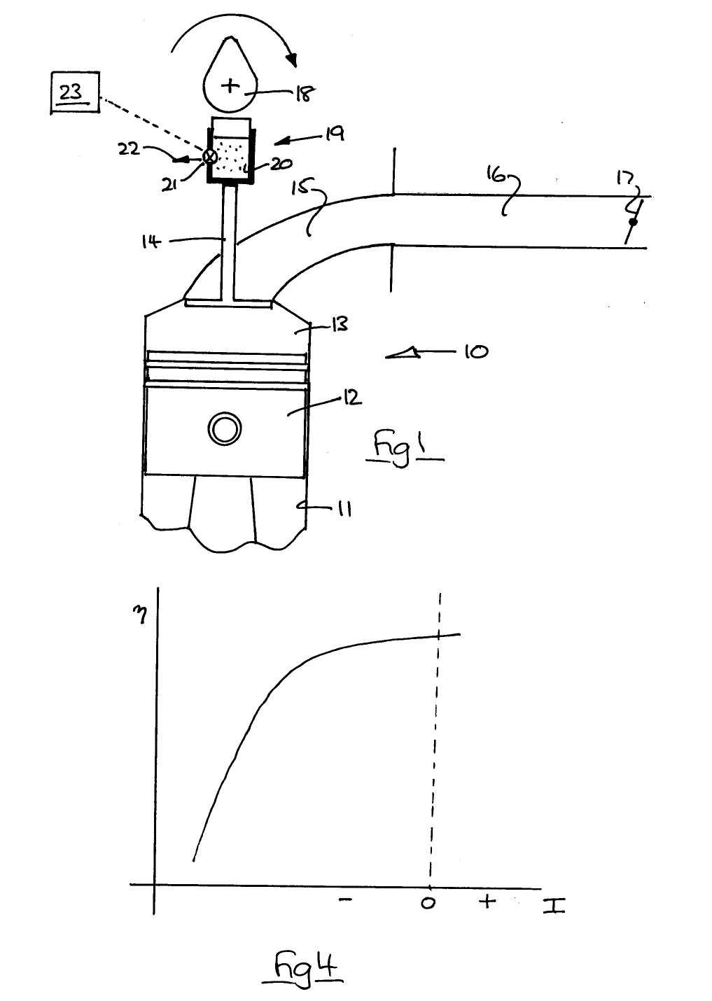

The generally arrangement of FIG. 1 is very common, and for ease of illustration certain other components, such as a corresponding poppet exhaust valve, are not illustrated. Conventionally a prior art tappet 19 is solid, and may be characterized as passive.

The tappet of FIG. 1 is however active, and is characterized in this embodiment by a hydraulic chamber 20 whose volume is determined according to opening and closing of a bleed valve 21 which allows escape of fluid as indicated by arrow 22. The chamber 20 receives a constant supply of oil under pressure, and by varying the opening of the bleed valve over time, the instant volume of oil in the chamber can be changed to affect the lift, duration and timing of the operation of the inlet valve. It will be understood that the active tappet may enhance, oppose or neutralize the effect of the cam 18. The kind of active tappet is not important save that it should permit fast variation of valve lift on an event basis. Thus it is envisaged that valve lift may be varied at each successive opening thereof, if required, for each cylinder of a multi-cylinder engine.

One example of an active tappet is disclosed in EP-A-2511504, and relies upon an electro-hydraulic device. Command of the active tappet is by an ECU 23.

Multiple inlet valves may be provided for the or each cylinder, and one or more such valves may be actuated by an active tappet, as required.

In use the admission of air into the engine is generally controlled via the throttle valve 17, which in turn is commanded by the ECU 23 according to conventional control parameters such as accelerator pedal position, altitude, air temperature and the like. It will be understood an alteration of the position of the throttle valve 17 changes the rate of air inflow, but does not immediately influence the amount of air admitted to the combustion chamber because of the air volume contained in the inlet manifold 16 and inlet tract 15.

FIG. 2 illustrates a prior art method of idle speed control, the inlet valve lift being operated by a fixed length tappet (i.e. a passive tappet). Successive ignition firing events of a four cylinder engine are indicated by trace F so that twelve such firing events (three combustion cycles for each cylinder) occur before t₂.

The parameters of FIG. 2 are shown vertically spaced on the y axis for the purposes of comparative illustration in time, but do not represent proportionate values.

Idle speed N is constant until t₁ where it falls; corrective action is taken at t₂, allowing engine speed to rise back to the original level at t₃. It will be understood that idle speed variation will in practice follow a more serpentine course, but in this example a simple reduction and increase will suffice to illustrate and explain the control method.

Air flow through the engine (Q) is a constant since inlet valve lift (L) is also constant. Air flow is however greater than required to generate the torque necessary to achieve the desired idling speed, but the torque generated is reduced by retarding the ignition timing I. Thus in the period prior to t₁, ignition timing is at a retarded value.

An engine speed falls in the period t₁-t₂, ignition timing I is advanced. In consequence combustion becomes more efficient, as the ignition timing approaches the optimum, and engine speed rises in the period t₂-t₃. Ignition timing can be varied very quickly, and accordingly the response of the engine to the increased demand for torque is instant (within one TDC). As a further consequence ignition timing is again retarded so as to prevent idle speed overshooting an upper limit. Cumulative exhaust emissions are represented by the trace E, and increase steadily over the period illustrated.

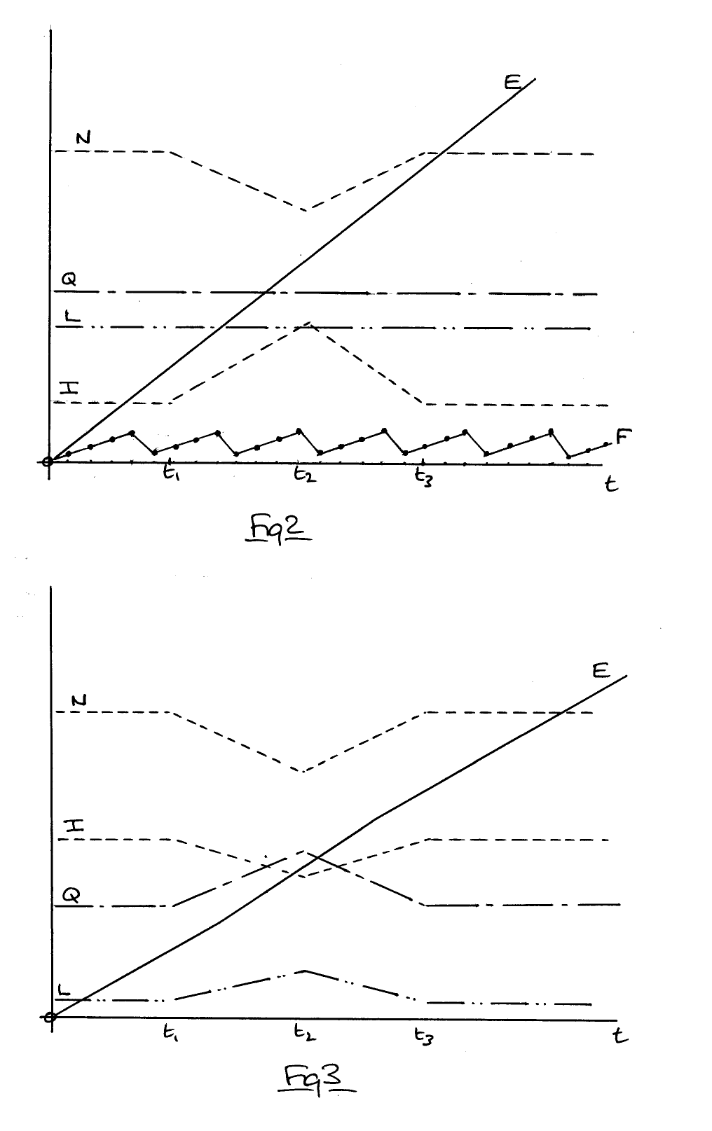

It will be understood that in this simplified explanation, certain control aspects are not fully considered. For example it is assumed that engine speed can be precisely controlled according to the illustration whereas in practice it may vary slightly and continuously within upper and lower limits. Ignition timing is varied on a cylinder by cylinder basis to achieve a fast response to a torque-up demand. The graph of FIG. 2 is primarily for the purposes of comparison with FIG. 3, which illustrates the effect of the invention upon an engine operating in identical circumstances.

FIG. 3 illustrates the same variation in engine speed as in FIG. 2. Ignition firing events are omitted to increase clarity, but are the same as for FIG. 2. Air flow Q is reduced in the period preceding t₁ by virtue of an active tappet, whereby valve lift (L) is substantially reduced as compared with FIG. 2, and the volume of air admitted to the cylinder is reduced to that commensurate with generating sufficient torque if combusted at full efficiency. Ignition timing has sufficient advance to ensure efficient combustion and is substantially more advanced than illustrated in FIG. 2.

Cumulative exhaust emissions (E), absent any other consideration, rise at a reduced rate by virtue of the reduced air flow, lower fuel consumption, and more efficient combustion.

The fall in engine speed in the period t₁-t₂ is countered by an increase in valve lift (L), by virtue of an adjustment of the length of the active tappet. Such adjustment is very rapid, and the response is commensurate with the response of a variation in ignition timing. The response time is fast enough to meet the required specification, and generally about an order of magnitude better than a response based on prior methods of adjusting valve operation or throttle valve adjustment.

As a consequence of an increase in valve lift, the aspiration of air (Q) into the engine is increased, so that greater torque results from combustion. Ignition timing (I) is adjusted slightly to maintain optimum combustion as airflow increases. Operation of successive inlet valves may be individually varied to ensure a smooth rapid torque increase.

The subsequent rise in engine speed in period t₂-t₃ results in a progressive reversion of valve lift and ignition timing to the previous levels, so that idle speed resumes the desired value. Cumulative exhaust emissions E are substantially reduced.

In an embodiment of the invention applied to a multi-cylinder engine, active tappets are provided on inlet valves of each cylinder and are activated independently. Accordingly cylinder by cylinder adjustment is possible so that idle speed may track a narrow band of e.g. 50 rpm or less. The lift of successively opening inlet valves may be different to permit a ramping-up and ramping-down of the effect of the invention, according to known methods of hysteresis control.

Not illustrated in FIGS. 2 and 3 is the comparative value of waste heat generated in combustion. Inefficient combustion (FIG. 2) inevitably introduces additional waste heat to the engine cooling system, which typically relies upon liquid coolant and a coolant/air radiator. During idling a vehicle is generally stationary, so that air flow through the radiator must be forced via a fan, and thus is a limiting condition for determining the ability of the radiator to reject heat—when moving, cooling is typically adequate without a fan, due to the relative motion of the radiator with respect to atmosphere.

The efficient combustion of FIG. 3 provides a reduced amount of waste heat, with the consequence that volume of the coolant and the coolant air radiator may be comparatively smaller for the idling case.

The use of active inlet valve tappets on one or more inlet valves of each cylinder of an internal combustion engine can be used alone to ensure a fast response to a torque-up and torque-down demand during idling. However additional variation of ignition timing to ensure spark optimisation and ignition efficiency may also be a useful technique.

FIG. 4 illustrates that combustion efficiency does not fall linearly with spark retardation. Efficiency (η) is plotted against ignition timing I with the zero point indicating spark timing for optimum combustion; to the left of the zero point ignition timing is retarded (−), and to the right ignition timing is advanced (+).

It will be observed that initially, retarding of ignition timing has relatively little effect upon efficiency of combustion, and accordingly a combination of adjustment of ignition timing and use of an active tappet is available for controlling idling speed within a narrow band.

Admission of fuel to the cylinders is not described above, but known methods may be employed to ensure that fuel admission is commensurate with air volume, so as to achieve substantially stoichiometric combustion. For example the ECU 23 may command an injection of fuel commensurate with the air inlet volume commanded via the bleed valve 21.

The foregoing example of FIG. 3 describes a variation of valve lift to vary the volume of air admitted via the inlet valve 14; duration of valve opening is determined by the profile of the cam 18.

However it will be understood that the bleed valve may be used to counter the action of the cam by for example delaying valve opening and valve closing. In one example fluid may be allowed to bleed from the chamber to precisely counteract the lifting effect of the cam.

It will thus be understood that the volume of air admitted into the cylinder may additionally, or alternatively, be varied by changing the duration of valve opening, and/or by changing the timing of valve opening and of valve closing.

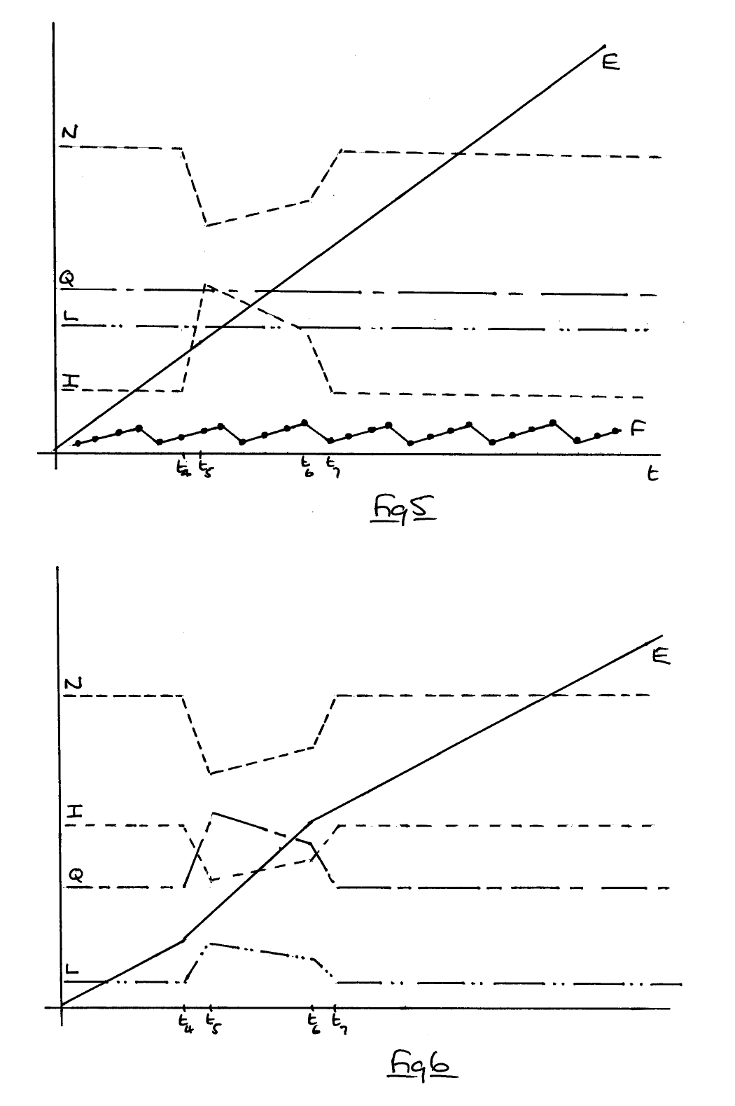

A further comparative example is illustrated in FIGS. 5 and 6, where common parameters are illustrated graphically.

A conventional response to a fall in engine speed N is illustrated in FIG. 5 and relies upon a deliberately retarded ignition in the period prior to t₄. A fall in engine speed between t₄ and t₅ results in an immediate advance of ignition timing between successive ignition firing events at t₄ and t₅, for successively firing cylinders of a four cylinder engine.

Engine speed rises abruptly between t₆ and t₇, with the consequence of an immediate retardation of ignition timing between successive firing pulses at t₆ and t₇.

During this period, valve lift L and air flow Q are constant, as in the example of FIG. 2.

FIG. 6 illustrates the comparative response according to the invention, by reference to a change of valve lift L. As noted above, the change in air admitted to each cylinder can be varied by an active tappet, to change valve lift, valve opening duration and valve timing, but in this example valve lift only is changed to vary inlet air volume Q.

Thus prior to t₄, the volume of inlet air Q is reduced compared with FIG. 5, and ignition timing I is advanced to ensure efficient and complete combustion. Upon detection of a fall in engine speed between t₄ and t₅ valve lift is immediately increased, for example by partial closing of the valve 21. As illustrated, the opening of successive valves may be changed, i.e. within one combustion event.

In consequence air flow Q is increased, and ignition timing is retarded to ensure continuing efficient combustion.

As engine speed increases, valve lift is reduced in successive combustion events, so that idling is controlled to the desired valve. Air flow falls, and ignition timing is re-advanced.

The comparison of accumulated emissions E, shows a marked reduction between the prior art arrangement of FIG. 5, and the arrangement according to the invention.

The invention is typically used for a vehicle engine, though application to non-vehicle installations is also envisaged.

Furthermore, in a practical vehicle installation, it is envisaged that the possibility of substantial variation of ignition timing will be retained, not only to allow efficient combustion throughout the range of engine speed, but also to provide redundancy in case of an error or fault relating to the active tappet or to the control system thereof.

Aspects of the invention will be apparent from the numbered paragraphs that follow:

1. A method of optimising idling of a reciprocating piston internal combustion engine having a poppet valve at the inlet of a cylinder, an inlet manifold, and a throttle valve at the inlet to said manifold, said engine further including an active tappet for said inlet valve whereby valve opening may be varied on demand, said method comprising:
detecting that engine speed is falling,
commanding said active tappet to increase the volume of air admitted at each actuation of the inlet valve,
detecting that engine speed is rising,
commanding said active tappet to reduce the volume of air admitted at each actuation of the inlet valve,
and repeating said method continually whilst said engine is idling.

2. A method according to aspect 1 wherein said active tappet is commanded to change one or more of inlet valve lift, inlet valve opening duration, inlet valve opening timing, inlet valve closing timing and overlap between inlet valve opening and opening of an exhaust valve of said cylinder.

3. A method according to aspect 1 wherein said engine is a spark ignition engine, the timing of the ignition spark being varied in accordance with the change in the volume of air admitted via said inlet poppet valve.

4. A method according to aspect 2 wherein said engine is a spark ignition engine, the timing of the ignition spark being varied in accordance with the change in the volume of air admitted via said inlet poppet valve.

5. A method according to aspect 3 the timing of an ignition spark being selected to provide optimum efficiency of combustion.

6. A method according to aspect 4 the timing of an ignition spark being selected to provide optimum efficiency of combustion.

7. A method according to aspect 5 wherein ignition timing is retarded when the admitted volume of air is increased.

8. A method according to aspect 6 wherein ignition timing is retarded when the admitted volume of air is increased.

9. A method according to aspect 5 wherein ignition timing is advanced when the admitted volume of air is reduced.

10. A method according to aspect 7 wherein ignition timing is advanced when the admitted volume of air is reduced.

11. A method according to aspect 1 wherein said active tappet permits a variation of an immediately succeeding valve opening in consequence of a determination of an engine speed variation after a preceding valve opening.

12. A method of aspect 1 wherein engine speed is maintained between predetermined upper and lower values.

13. A method of aspect 1 wherein said active tappet comprises a hydraulic chamber having an electrically commanded valve to vary the instant volume thereof.

14. A method according to aspect 13 wherein said hydraulic chamber is provided with a substantially unobstructed inlet flow of liquid oil, and includes a solenoid controlled bleed valve to vary outlet flow therefrom.

15. A method of aspect 1 applied to a multi-cylinder engine having an active tappet for an inlet valve of each cylinder thereof.

16. A method according to aspect 14 wherein each active tappet is independently commanded by an electronic control unit of said engine to change the volume of air admitted to a respective cylinder for successive engine combustion events.

17. A method of aspect 1 applied to a cam actuated poppet inlet valve.

18. A control system for implementing the method of aspects 1-17, said control system comprising an electronic control unit having a processor for electronically commanding said active tappet according to an idle speed control parameter contained in a memory of said processor.

19. A reciprocating piston gasoline engine having a plurality of cylinders, an inlet valve for each cylinder and an active tappet for each said inlet valve, said engine being adapted for operation according to the method of any of aspects 1-17.

20. A vehicle incorporating the engine of aspect 19 and an electronic control systems for implementing the method.

1-18. (canceled)

19. A method of optimizing idling of a reciprocating piston internal combustion engine having an inlet valve at the inlet of a cylinder, and an active tappet for said inlet valve whereby valve opening may be varied on demand, said method comprising:
detecting that engine speed is falling,
commanding said active tappet to increase a volume of air admitted at each actuation of the inlet valve when the engine speed is falling,
detecting that engine speed is rising,
commanding said active tappet to reduce the volume of air admitted at each actuation of the inlet valve when the engine speed is rising,
and repeating said method continually while said engine is idling.

20. A method according to claim 19, wherein the engine is a multi-cylinder engine having an active tappet for an inlet valve of each cylinder.

21. A method according to claim 20, wherein each active tappet is independently commanded by an electronic control unit of said engine to change the volume of air admitted to a respective cylinder for successive engine combustion events.

22. A method according to claim 19, wherein said active tappet is commanded to change one or more of inlet valve lift, inlet valve opening duration, inlet valve opening timing, inlet valve closing timing and overlap between inlet valve opening and opening of an exhaust valve of said cylinder.

23. A method according to claim 19, wherein said engine is a spark ignition engine, and the method includes varying a timing of the ignition spark in accordance with the change in the volume of air admitted via said inlet valve.

24. A method according to claim 23, wherein the timing of the ignition spark is selected to provide a selected type of combustion.

25. A method according to claim 24, wherein the timing of the ignition spark is retarded when the admitted volume of air is increased.

26. A method according to claim 24, wherein the timing of the ignition spark is advanced when the admitted volume of air is reduced.

27. A method according to claim 19, wherein said active tappet permits a variation of an immediately succeeding valve opening in consequence of a determination of an engine speed variation after a preceding valve opening.

28. A method of claim 19, wherein engine speed is maintained between predetermined upper and lower values.

29. A method of claim 19, wherein said active tappet comprises a hydraulic chamber having an electrically commanded valve to vary an instant volume of the hydraulic chamber.

30. A method according to claim 29, wherein said hydraulic chamber is provided with a substantially unobstructed inlet flow of liquid oil, and includes a solenoid controlled bleed valve to vary outlet flow from the hydraulic chamber.

31. A method of claim 19, wherein the inlet valve comprises a cam actuated poppet inlet valve.

32. A control system, comprising:
an electronic control unit having a processor and a memory associated with the processor, the processor being configured for electronically commanding an active tappet of an engine cylinder inlet valve according to an idle speed control parameter contained in the memory, the processor being configured for
detecting that engine speed is falling,
commanding said active tappet to increase a volume of air admitted at each actuation of the inlet valve when the engine speed is falling,
detecting that engine speed is rising,
commanding said active tappet to reduce the volume of air admitted at each actuation of the inlet valve when the engine speed is rising,
and repeating said method continually while said engine is idling.

33. A reciprocating piston gasoline engine, comprising:
a plurality of cylinders;
an inlet valve for each cylinder; and
an active tappet for each said inlet valve, said engine being configured for operation according to a method that comprises
detecting that engine speed is falling,
commanding said active tappet to increase a volume of air admitted at each actuation of the inlet valve when the engine speed is falling,
detecting that engine speed is rising,
commanding said active tappet to reduce the volume of air admitted at each actuation of the inlet valve when the engine speed is rising,
and repeating said method continually while said engine is idling.

34. A vehicle incorporating the engine of claim 33, and an electronic controller configured for controlling the operation of the engine.
